(19) United States
(12) Patent Application Publication
(10) Pub. No.: US 2001/0001550 A1
(43) Pub. Date: May 24, 2001

(54) INTEGRAL STRESS ISOLATION APPARATUS AND TECHNIQUE FOR SEMICONDUCTOR DEVICES

(76) Inventors: JANUSZ BRYZEK, FREMONT, CA (US); DAVID W. BURNS, SAN JOSE, CA (US); STEVEN S. NASIRI, SARATOGA, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/190,739

(22) Filed: Nov. 12, 1998

(51) Int. Cl. H01C 10/10

(52) U.S. Cl. 338/36

(57) ABSTRACT

A semiconductor device die comprising one or more stress-isolated regions is described. In one embodiment, stress isolation is achieved by providing a nominally rigid rim region which forms part of the stress isolated region. The rim region is attached to a nominally rigid periphery or frame region by a flexible, spring-like stress-isolation region such that displacements and twisting of the frame region due to mounting and packaging stresses are mitigated, do not propagate to the stress-isolated region, and do not effect the output signal. The stress isolation flexible region includes first and second members etched from the semiconductor device material to mechanically isolate the diaphragm from its periphery. The first member is formed by etching a first deep trench. The combination of the first deep trench etch and a second deep trench etch define the second member. In one embodiment, the stress-isolated region comprises a pressure-sensitive deformable diaphragm for sensing pressure. In another embodiment, one or more electronic device may be incorporated on the stress-isolated region.

### BACKGROUND OF THE INVENTION

1. Field of the Invention

The present invention relates generally to semiconductor devices, and specifically, to stress isolation techniques for semiconductor devices.

2. Background Information

Semiconductor devices such as pressure sensors, accelerometers, flow sensors, micro-mechanical filters, operational amplifiers, and voltage references are often performance-limited by detrimental packaging and mounting stresses. The materials typically used in the package and die attachment are hysteretic, are thermally mismatched with the semiconductor die, and in general do not sufficiently isolate the critical element from torques and stresses due to mounting and device operation over extended pressure, temperature, and time.

FIG. 1 is a cross-sectional view of a conventional semiconductor pressure sensor 10. Referring to FIG. 1, the semiconductor pressure sensor 10 consists of a silicon sensor die 12 that includes a rim region 14 and a diaphragm region 16, and is attached at its bottom surface 18 to an external package 20. Differential pressure is externally applied from the top (P0) and/or bottom (P1) to deflect the diaphragm region 16. For absolute pressure sensing, a reference pressure, typically a vacuum, is applied to one side of the diaphragm 16, and the pressure to be sensed is applied to the other side of the diaphragm 16.

FIG. 2 is a top view of the conventional silicon pressure sensor of FIG. 1. In this view, four piezoresistive elements R1-R4 are formed in the top surface at the diaphragm periphery. Resistors R1 and R3 are aligned parallel to their respective diaphragm edges 22₁ while resistors R2 and R4 are aligned perpendicular to their respective diaphragm edges 22₂. The resistors are connected in a Wheatstone bridge configuration, as shown in FIG. 3, where the resistances of resistors R1 and R3 increase in value and the resistances of resistors R2 and R4 decrease in value with increased pressure P1. The bridge output, Vo, varies with the amount of pressure applied to the diaphragm.

FIG. 4 illustrates an exaggerated deflection profile of the pressure-sensitive diaphragm 16. The applied pressure deflects the diaphragm 16, resulting in compressive bending stresses at the top-side of the diaphragm near the edges 24, and tensile bending stresses at the top near the center 26 of the diaphragm. The bending stresses change the resistance of the piezoresistive elements, which in turn changes the output voltage Vo of the Wheatstone bridge.

The output voltage Vo, however, varies also with in-plane stresses generated from the package and communicated to the sensor diaphragm through the bottom surface and perimeter region of the sensor die, or through any material (such as over-molding or corrosion-resistant coatings) in physical contact with the sensor die.

### SUMMARY OF THE INVENTION

The present invention comprises a semiconductor device die comprising one or more stress-isolated regions. In one embodiment, stress isolation is achieved by providing a nominally rigid rim region surrounding the one or more stress-isolated regions. The rim region is attached to a nominally rigid periphery or frame region by a flexible, spring-like stress-isolation region such that displacements and twisting of the frame region due to mounting and packaging stresses are mitigated, do not propagate to the stress-isolated region, and do not effect the output signal. The stress isolation flexible region includes first and second members etched from the semiconductor device material to mechanically isolate the diaphragm from its periphery. The first member is formed by etching a first deep trench. The combination of the first deep trench etch and a second deep trench etch define the second member.

In one embodiment, the stress-isolated region comprises a pressure-sensitive deformable diaphragm for sensing pressure. In another embodiment, one or more electronic devices may be incorporated on the stress-isolation region.

### BRIEF DESCRIPTION OF THE DRAWINGS

FIG. 1 is a cross-sectional view of a conventional semiconductor pressure sensor.

FIG. 2 is a top view of the conventional silicon pressure sensor of FIG. 1.

FIG. 3 illustrates the Wheatstone bridge connection of the piezoresistive elements.

FIG. 4 illustrates an exaggerated deflection profile of the pressure-sensitive diaphragm.

FIG. 5 illustrates a cross-sectional view of a silicon pressure sensor according to one embodiment of the present invention.

FIG. 6 illustrates an expanded view of the stress isolation flexible region of the embodiment of FIG. 5.

FIG. 7 is a schematic cross-sectional illustration of the stress-isolation flexible region of the present invention.

FIG. 8 illustrates a cross-sectional view of a silicon pressure sensor according to another embodiment of the present invention.

FIG. 9a is a top view of the stress-isolated pressure sensor according to one embodiment of the present invention.

FIG. 9b is a top view of the stress-isolated pressure sensor according to another embodiment of the present invention.

FIG. 10 is a perspective view illustrating a stress-isolated region on a semiconductor die.

FIG. 11 illustrates a schematic cross section of a semiconductor device incorporating the stress isolation technique of the present invention.

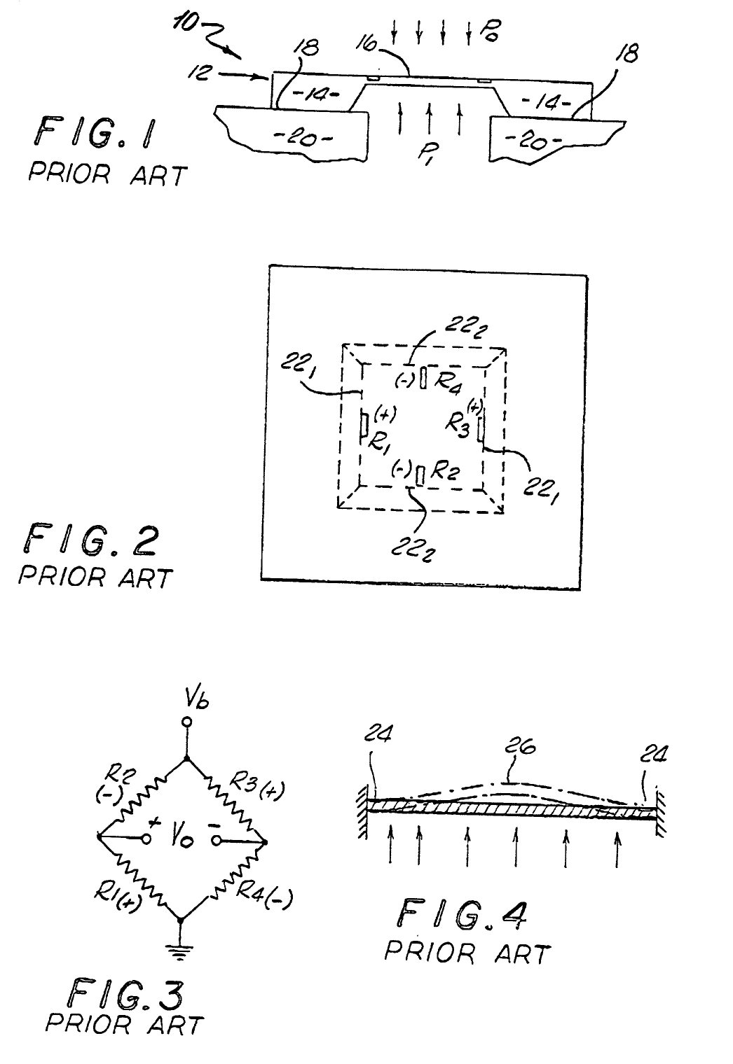

### DETAILED DESCRIPTION

The present invention comprises a stress isolation apparatus and technique for semiconductor sensors and devices. In one embodiment, stress isolation is achieved by providing a rim region surrounding a pressure-sensitive deformable diaphragm, which provides a nominally rigid support for diaphragm flexing. The rim region is attached to a nominally rigid periphery or frame region by a flexible, spring-like region such that displacements and twisting of the frame region due to mounting and packaging stresses are mitigated, do not propagate to the diaphragm region, and do not effect the output signal. For sake of clarity and illustration of the present invention, the stress isolation apparatus and technique will be described primarily with respect to such semiconductor pressure sensor applications. However, it is apparent to one skilled in the art that the present invention may be used with other semiconductor devices, as subsequently described in greater detail.

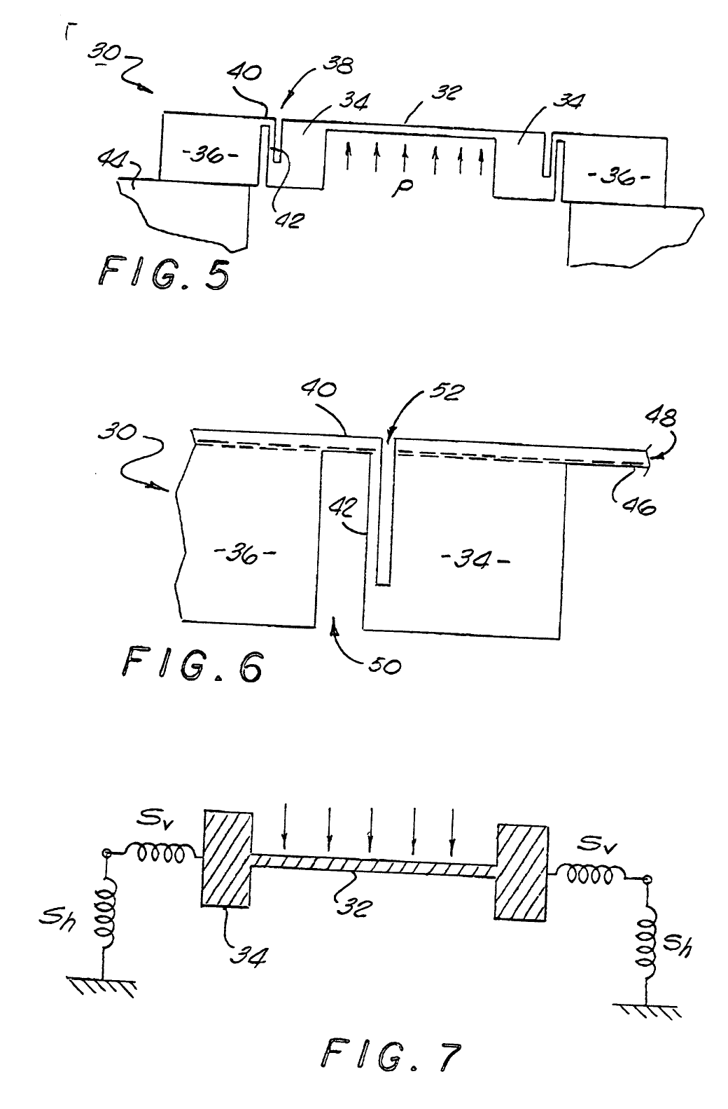

FIG. 5 illustrates a cross-sectional view of a silicon pressure sensor 30 according to one embodiment of the present invention. The silicon pressure sensor 30 includes a diaphragm region 32 which is surrounded and supported by a nominally rigid rim region 34. A spring-like, stress isolation flexible region 38 supports the rim region 34 and is integral with a frame region 36. Specifically, the stress isolation flexible region 38 comprises two laterally flexible members, namely, a first member 40 extending horizontally to the frame region 36 (hereinafter referred to as the “horizontal member”) and a second member 42 extending vertically at one end to the horizontal member 40 and at the other end to the nominally rigid rim region 34 (hereinafter referred to as the “vertical member”). The frame region 36 is attached to a package 44.

FIG. 6 illustrates an expanded view of the stress isolation flexible region 38 of the embodiment of FIG. 5. As shown in FIG. 6, the horizontal and vertical members 40 and 42 are thin, flexible members. In one embodiment, the horizontal and vertical members 40 and 42 have an aspect ratio (length to thickness) of approximately 3 to 1 and 10 to 1, respectively. That is, the length of the horizontal member 40 is approximately three times its thickness and the length of the vertical member 42 is approximately ten times its thickness, thereby providing good flexibility to confine externally generated stresses to the frame region 36 only. Of course, other aspect ratios may be used depending on a number of factors including, but not limited to, the amount of stress that the frame region 36 is to be subjected to, the thickness of the diaphragm 32, etc.

Continuing to refer to FIG. 6, prior to formation of the horizontal and vertical members 40 and 42, and the diaphragm 32, an oxide layer 46 is incorporated in the silicon substrate 30 using a Silicon Implanted with Oxygen (“SIMOX”) or Bonded and Etched Silicon-on-Insulator (“BESOI”) technique commonly known to those skilled in the art. An epitaxial layer 48 is optionally deposited above the oxide layer 46 to thicken the diaphragm 32 as needed. The oxide layer 46 provides a suitable etch stop for a bottom side etch. Alternatively, in lieu of using the oxide layer 46, a time based etch stop can be implemented.

The horizontal and vertical members 40 and 42 of the flexible region 38 are formed by vertically etching lower and upper trenches 50 and 52 from the bottom and the top of the sensor die 30, respectively. The horizontal and vertical members 40 and 42 support the nominally rigid rim region 34 near the center, with the same providing support for the pressure-sensitive diaphragm 32, which may be formed using the same etching steps as used to form the lower trench 50. Formation of the horizontal and vertical members 40 and 42 is preferably achieved using a deep reactive ion etching (“D-RIE”), a known technique which allows deep trenches to be etched in silicon with high aspect ratios and nearly vertical walls on either side of the wafer.

Referring to FIGS. 5 and 6, metal traces, connected to the piezoresistive elements (not shown), are routed from the diaphragm 32 (or stress isolated region) to the frame region 36 for external interconnection. In the stress isolation flexible region 38, the metal traces are routed over the upper trench 52 using a cross-over technique (which is described below). Alternatively, bonding pads may be placed on both sides of the upper trench 52 with the bonding pads being connected by conventional bonding wires.

Accuracy in the thickness of the horizontal member 40 and deformable diaphragm 32 is enhanced by the inclusion of the oxide layer 46 at a depth from the top surface equal to the desired thickness of the diaphragm, since the etch rate of such oxide is much slower than that of bulk silicon. Electric discharge machining or other milling techniques may also be used to form the flexible horizontal and vertical members 40 and 42.

The dimensions of the diaphragm region 32, rim region 34, horizontal member 40, and vertical member 42 are selected in such a way as to provide the maximum amount of signal from the piezoresistive elements with applied pressure while avoiding fracture, with a minimum amount of sensitivity to influences at the periphery of the sensor die. It is important to note that the strength of the horizontal member 40 increases with the diaphragm thickness when using the etch stop fabrication technique, such that over-pressure requirements are maintained independent of the pressure range. Although described herein as being applied to pressure sensors with piezoresistive sensing, the present invention may be used with other pressure sensors using other “pickoff” techniques, such as capacitive or resonant sensing.

FIG. 7 is a schematic cross-sectional illustration of the stress-isolation flexible region of the present invention. The deformable diaphragm 32 is connected to the nominally rigid rim region 34 on all sides. The horizontal and vertical members 40 and 42 act as spring-like members Sₕ and Sᵥ, respectively, to support the diaphragm 32. Operating in tandem, the vertical and horizontal members 40 and 42 isolate the rim region and deformable diaphragm from shear stresses, and tension and compression stresses which occur at the die periphery.

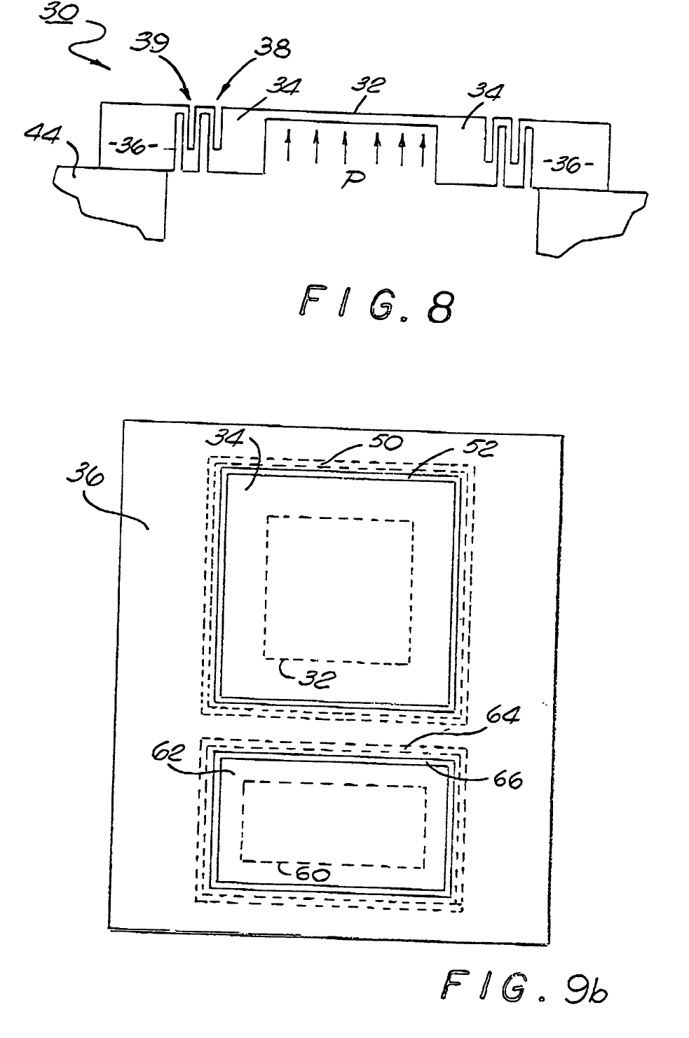

FIG. 8 illustrates a cross-sectional view of a silicon pressure sensor 30 according to another embodiment of the present invention. In this embodiment, the silicon pressure sensor 30 includes a second stress isolation flexible region 39 which surrounds the stress isolation flexible region 38. This second stress isolation region 39 provides further isolation of the diaphragm region 32 from mounting and packaging stresses. Similar to the stress isolation region 38, the second stress isolation region 39 includes horizontal and vertical members, which are formed by vertically etching lower and upper trenches from the bottom and the top of the sensor die 30, respectively (not labeled). Formation of the horizontal and vertical members of the second stress isolation region 39 may also be achieved using the D-RIE technique, and may be formed at the same time as the horizontal and vertical members of the stress isolation region 38 are formed. It is to be appreciated that the spacing between the stress isolation regions 38 and 39 may vary depending on design choice. It is also to be appreciated that more than two stress isolation regions may be provided.

FIG. 9a is a top view of the stress-isolated pressure sensor according to one embodiment of the present invention. In the embodiment shown, the diaphragm 32 is shaped as a square. However, the diaphragm may be formed of any shape such as, for example, a circular diaphragm. In addition, the diaphragm 32 may include bosses (thickened regions) or grooves spaced apart and incorporated on one side. Four piezoresistive elements are disposed on the surface of the diaphragm 32 and are connected in a Wheatstone bridge configuration for sensing bending stresses of the diaphragm 32 and providing an output signal in response thereto. The lower trench 50 defines the horizontal member (see FIG. 6) whereas the upper trench 52 fabricated in close proximity to the lower trench 50 forms the vertical member (see FIG. 6). Crossover regions for electrical interconnections are not shown.

FIG. 9b is a top view of the stress-isolated pressure sensor according to another embodiment of the present invention. In this embodiment, two stress isolated (or diaphragm regions) are provided on a semiconductor die, namely a first diaphragm region 32 and a second diaphragm region 60. The first diaphragm region 32 is similar to the diaphragm region of FIG. 9a, and is surrounded by a rim region 34 and upper and lower trenches 52 and 50. The second diaphragm region 60 is surrounded by a separate rim region 62, which is in turn surrounded by separate upper and lower trenches 66 and 64. In this embodiment, the diaphragm regions 32 and 60 are shown as having square and rectangular shapes, respectively, although other shapes may be formed. This embodiment may be used in a situation where two separate pressure sensors sense two separate pressure ranges. In another embodiment, one diaphragm region has piezoresistors incorporated thereon for sensing pressure, while the other diaphragm includes electronic circuitry (e.g., operational amplifiers, voltage references, and other circuits which may benefit from stress isolation) incorporated thereon. In yet another embodiment, the two diaphragm regions 32 and 60 have incorporated thereon two separate electronic circuits that have different power dissipation.

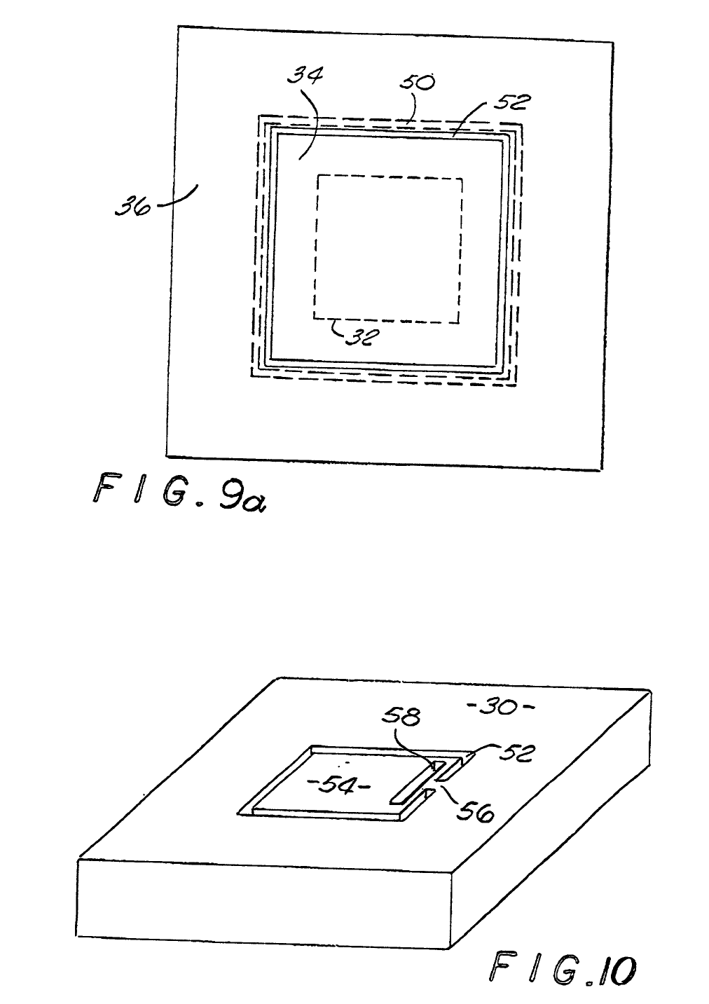

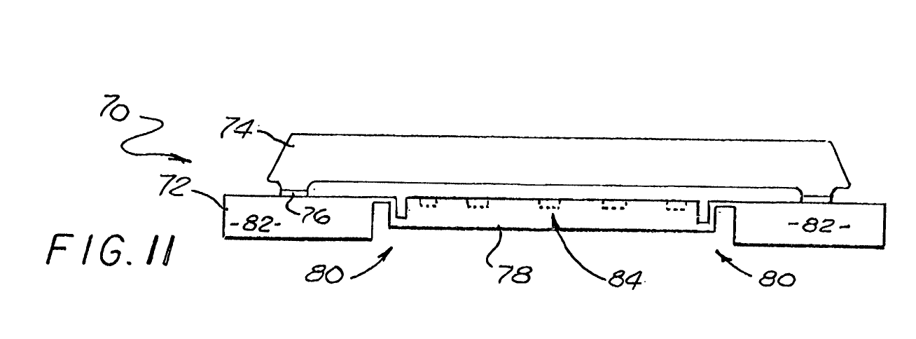

FIG. 10 is a perspective view illustrating a stress-isolated region 54 on a semiconductor die. In one embodiment, the stress-isolated region 54 supports active devices such as voltage references and operational amplifiers, or micro-mechanical devices such as accelerometers or micro-mechanical filters (See, e.g., FIG. 11). A cross-over region 56 is provided over the upper trench 52 for routing metal traces to and from the stress-isolated region 54 (e.g., such as the traces that are connected to the piezoresistive elements). Supplemental isolation may optionally be provided by using a rectangular upper trench 56 in close proximity to the cross-over region 56.

FIG. 11 illustrates a schematic cross section of a semiconductor device 70 incorporating the stress isolation technique of the present invention. As shown in FIG. 11, the semiconductor device 70 includes a semiconductor die 72 that is bonded (e.g., using a thermocompression bond) to a silicon cap wafer 74, as shown by numeral 76. The semiconductor die 72 includes a stress-isolated region 78, a stress isolation region 80, and a frame region 82 which is typically attached to a package (not shown). One or more electronic circuitry 84 is incorporated on the stress-isolated region 78 (as indicated by dashed lines). Examples of such circuitry include micro-mechanical components and semiconductor devices such as, for example, micro-mechanical filters or sealed voltage references. With the addition of the stress isolation region 80, displacements and twisting of the frame region 82 due to mounting and packaging stresses are mitigated, do not propagate to the stress-isolated region 78, and do not effect the output signal of devices located in the stress-isolated region 78.

As can be seen in FIG. 11, the stress isolation technique of the present invention applies to surface micro-machined devices such as micro-mechanical filters and oscillators, where a section of the die containing flexural resonant members benefits from the stress isolation flexible region and technique which minimizes the impact of package-induced stresses on the center frequency of the filter. Other surface micro-machined devices such as accelerometers and more common devices such as operational amplifiers and voltage references may also benefit from the stress isolation flexible region of the present invention. The stress isolation flexible region also provides a benefit of increased thermal isolation by way of using the vertical and horizontal members due to an increase in the thermal path length and a decrease in the thermal path area.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A semiconductor device die of semiconductor material, comprising:
one or more stress isolated regions; and
first and second members etched from said semiconductor material substantially around the one or more stress isolated regions to mechanically isolate the same from its periphery.

2. The semiconductor device die of claim 1 wherein a first trench etch is used to define the first member.

3. The semiconductor device die of claim 2 wherein the first trench etch is substantially perpendicular to the one or more stress-isolated regions to form the first member, the first member being substantially parallel to the one or more stress-isolated regions.

4. The semiconductor device die of claim 2 wherein a second trench etch is used such that the combination of the first and second trench etches define the second member.

5. The semiconductor device die of claim 4 wherein the second trench etch is substantially perpendicular to the one or more stress-isolated regions such that the combination of the first and second trench etches define the second member, the second member being substantially perpendicular to the one or more stress-isolated regions.

6. The semiconductor device die of claim 1 wherein the stress-isolated region senses external pressure.

7. The semiconductor device die of claim 6 wherein the stress-isolated region comprises a deformable diaphragm that is supported by a nominally rigid rim region.

8. The semiconductor device die of claim 7 wherein the diaphragm contains one or more stress-sensitive piezoresistive elements for electrically measuring deformations in the diaphragm due to external pressure applied thereto.

9. The semiconductor device die of claim 7 wherein the diaphragm is formed in the same etch step as the first member.

10. The semiconductor device of claim 2 further comprising a buried oxide layer to provide an integral etch stop for the first member.

11. The semiconductor device of claim 2 further comprising one or more electronic devices incorporated on the stress-isolated region.

12. The semiconductor device of claim 11 wherein the one or more electronic devices include one or more of the following in any combination: micro-mechanical filters, voltage references, oscillators, accelerometers, and operational amplifiers.

13. A semiconductor die, comprising:
a first region;
a frame region formed around the periphery of the first region; and
a stress isolation region formed between the first region and the frame region, the stress isolation region being formed substantially around the periphery of the first region to support and mechanically isolate the first region from the frame region.

14. The semiconductor die of claim 13 wherein the first region is a diaphragm.

15. The semiconductor die of claim 13 wherein the stress isolation region comprises first and second members formed by etching upper and lower trenches that are substantially perpendicular to the diaphragm and spaced apart by a first distance.

16. The semiconductor die of claim 15 wherein the first member is substantially parallel to and the second member is substantially perpendicular to the first region.

17. The semiconductor die of claim 13 further comprising a rim region formed between the first region and the stress isolation region.

18. The semiconductor die of claim 13 further comprising a package, the frame region being attached to the package.

19. The semiconductor die of claim 15 wherein a length of each of the first and second members is more than one times a thickness of each of the respective first and second members.

20. The semiconductor die of claim 13 further comprising a second stress isolation region formed closer to a center of the first region, the second stress isolation region formed around the periphery of the first region.

21. The semiconductor die of claim 13 further comprising one or more electronic devices incorporated on the first region.

22. The semiconductor die of claim 21 wherein the one or more electronic devices include one or more of the following in any combination: micro-mechanical filters, voltage references, oscillators, accelerometers, and operational amplifiers.

23. The semiconductor die of claim 13 further comprising a second stress isolation region formed between the frame region and the stress isolation region and surrounds the stress isolation region, said second stress isolation region to further isolate the first region from the frame region.

24. The semiconductor die of claim 13 further comprising:
a second region; and
a second stress isolation region formed around the second region.

25. The semiconductor die of claim 24 wherein the second stress isolation region mechanically isolates the second region from the frame region.

26. A method of mechanically isolating a deformable region from a frame region, comprising the combined acts of:
etching a first trench from a back-side of the semiconductor die around the periphery of the deformable region to form a first member; and
etching a second trench proximate to the first trench from a topside of the semiconductor die around the periphery of the deformable member such that the combination of the first and second trenches form a second member.
